(19) United States
(12) Patent Application Publication
(10) Pub. No.: US 2024/0195904 A1
(43) Pub. Date: Jun. 13, 2024

(54) NLP-BASED CALL MONITORING METHOD FOR PREVENTING VOICE PHISHING AND APPARATUS THEREFOR

(71) Applicant: Solugate Inc., Seoul (KR)

(72) Inventors: Sung Tae MIN, Seoul (KR); Seon Kyo SHIN, Seoul (KR); Buyong Ho LIM, Incheon (KR)

(73) Assignee: Solugate Inc., Seoul (KR)

(21) Appl. No.: 18/471,477

(22) Filed: Sep. 21, 2023

(30) Foreign Application Priority Data
Dec. 13, 2022 (KR) 10-2022-0173427

(51) Int. Cl. H04M 1/654; H04M 1/66

(52) U.S. Cl. CPC H04M 1/654; H04M 1/66

(57) ABSTRACT

Disclosed is a natural language processing (NLP) based call monitoring method for preventing voice phishing. The method includes the operations of: verifying a calling number ID when a call is received; when a voice signal of a caller is received, recognizing the caller's voiceprint, and firstly confirming whether the recognized voiceprint matches the voiceprint of a known voice phisher; based on the caller's speech keywords and speech patterns, secondly confirming whether voice phishing is or is not occurring; determining the caller as a voice phisher based on the risk score derived from the first confirmation and the second confirmation; and when the caller is determined as a voice phisher, taking corresponding measures. Therefore, frequency of damages due to voice phishing can be reduced.

### CROSS-REFERENCE TO RELATED APPLICATION

A claim for priority under 35 U.S.C. § 119 is made to Korean Patent Application No. 10-2022-0173427 filed on Dec. 13, 2022 in the Korean Intellectual Property Office, the entire contents of which are hereby incorporated by reference.

### BACKGROUND

### 1. Technical Field

The present disclosure relates to a natural language processing (NLP) based call monitoring method for preventing voice phishing, and an apparatus therefor.

### 2. Description of Related Art

Voice phishing is one type of fraudulent crime that aims to deceive to misappropriate another's property, namely, a type of special fraud crime in the financial field occurring through non-face-to-face transactions using electronic communication means.

Voice phishing arises from the fact that general users have a relatively low level of security awareness. In the instance of voice phishing conducted over the phone, when an attacker, who is a caller, impersonates a renowned institution, such as a bank or a post office, the users may accept the caller's words doubtlessly, and it is an attack method that deceives users externally regardless of the internal security levels of the corresponding institution.

The process by which the attacker deceives the user is simple, that is, to call to a user and impersonate a certain institution is all the process of deceiving the user entails. While the phone number of the attacker is displayed on the user's phone, one does not know whether the phone number truly belongs to the institution.

As described above, voice phishing is an easily conceived and cost-effective attack method with good accessibility for attackers. However, appropriate countermeasures for voice phishing have not yet been presented. Accordingly, despite advancements in security technology, the number of voice phishing incidents has been increasing.

Therefore, there is a need for a method to effectively detect voice phishing and prevent damages in advance.

### SUMMARY

The present disclosure has been made to solve the above-mentioned problems occurring in the prior art, and in an aspect of the present disclosure, an object of the present disclosure is to provide a method that recognizes the voiceprint of a call maker and quickly determines whether the recognized voiceprint is or is not that of a known voice phisher.

Another object of the present disclosure is to provide a method that extracts the speech pattern and speech keywords of the call maker and compares them with previously stored voice phishing speech patterns and speech keywords to determine whether a call maker is a voice phisher or not.

The aspects of the present disclosure are not limited to those mentioned above, and other aspects not mentioned herein will be clearly understood by those skilled in the art from the following description.

To accomplish the above-mentioned objects, according to an aspect of the present invention, there is provided a natural language processing (NLP) based call monitoring method for preventing voice phishing including the operations of: verifying a calling number ID when a call is received; when a voice signal of a caller is received, recognizing the caller's voiceprint, and firstly confirming whether the recognized voiceprint matches the voiceprint of a known voice phisher; based on the caller's speech keywords and speech patterns, secondly confirming whether voice phishing is or is not occurring; determining the caller as a voice phisher based on the risk score derived from the first confirmation and the second confirmation; and when the caller is determined as a voice phisher, taking corresponding measures.

The operation of verifying the calling number ID comprises the operations of: when the calling number ID is not previously stored in a phone book, searching for the calling number ID in a voice phishing blacklist database (DB); and when the calling number ID is discovered in the blacklist DB, terminating the received call and initiating a reporting process to the relevant authority.

The operation of verifying the calling number ID comprises the operations of: when the call location of the calling number ID is not domestic but international, even if the calling number ID is not discovered in the voice phishing blacklist DB, reflecting the calling number ID in the risk score calculation; and triggering a call record command.

The firstly confirming operation comprises the operations of: searching for the recognized voiceprint of the caller in a voice phisher voiceprint DB; when the voiceprint of the caller is recognized, reflecting the voiceprint in the risk score calculation; and triggering a call record command.

The firstly confirming operation comprises the operations of: when the caller claims to have kidnapped a recipient's family member or acquaintance and provides the kidnapped person's voice for verification, comparing the voiceprint of the provided voice with the previously stored voiceprint of the family member or acquaintance; and when the comparison result shows a predetermined similarity, reflecting the comparison result in the risk score calculation.

The secondly confirming operation comprises the operations of: processing the caller's voice into spoken text based on speech to text (STT); comparing the speech keywords of the spoken text with the speech keywords of voice phishing, and comparing the speech patterns of the spoken text with the speech patterns of voice phishing; and when there is a certain degree of similarity as a result of the comparison, reflecting the comparison result in the risk score calculation.

The secondly confirming operation comprises the operations of: when the risk score, as a result of the verification and the first confirmation, exceeds a predetermined level, even if the comparison result using speech patterns and speech keywords is lower than a predetermined level, reflecting the result in the risk score calculation.

The operation of determining the caller as a voice phisher comprises the operations of: utilizing a pre-trained model at the time of the risk score calculation, wherein the model is trained by assigning weighted values to at least one of a case in which the calling number ID is not stored in the phone book, a case in which a call is received from an international source, a case in which the caller's voice has a certain similarity with a preregistered voice phisher's voice, a case in which the caller's speech keywords have a certain (or pre-set) similarity with frequently used keywords by voice phishers, and a case in which the caller's speech pattern has a certain similarity with the speech pattern of a voice phisher.

In another aspect of the present invention, there is provided a natural language processing (NLP) based call monitoring apparatus, including: a communication unit; and a control unit which verifies a calling number ID when a call is received, recognizes the caller's voiceprint when a voice signal of a caller is received, firstly confirms whether the recognized voiceprint matches the voiceprint of a known voice phisher, and based on the caller's speech keywords and speech patterns, secondly confirms whether voice phishing is or is not occurring, wherein the control unit determines the caller as a voice phisher based on the risk score derived from the first confirmation and the second confirmation, and when the caller is determined as a voice phisher, takes corresponding measures.

Besides the above, a computer program stored in a computer readable recording medium for embodying the present disclosure may be additionally provided.

Besides the above, a computer readable recording medium to record computer programs for executing the method may be additionally provided.

### BRIEF DESCRIPTION OF THE DRAWINGS

FIG. 1 is a view illustrating a situation that a natural language processing (NLP) based fraudulent call monitoring apparatus for preventing voice phishing according to the present disclosure is applied.

FIG. 2 is a view illustrating a system for preventing voice phishing according to the present disclosure.

FIG. 3 is a block diagram illustrating a natural language processing (NLP) based fraudulent call monitoring apparatus for preventing voice phishing according to the present disclosure.

FIG. 4 is a sequence chart illustrating a natural language processing (NLP) based fraudulent call monitoring method for preventing voice phishing according to the present disclosure.

FIG. 5 is a sequence chart depicting a calling number ID verification method for preventing voice phishing according to the present disclosure.

FIG. 6 is a sequence chart depicting a method of analyzing speech patterns and speech keywords for preventing voice phishing according to the present disclosure.

FIG. 7 is a view depicting a user interface of the NLP based fraudulent call monitoring apparatus for preventing voice phishing according to the present disclosure.

### DETAILED DESCRIPTION

In the drawings, like reference numerals designate like components. This disclosure does not describe all components of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one component, or a unit, a module, a member, or a block may include a plurality of components.

Throughout this specification, when a part is referred to as being “connected” to another part, this includes “direct connection” and “indirect connection”, and the indirect connection may include connection via a wireless communication network. Furthermore, when a certain part “includes” a certain component, other components are not excluded unless explicitly described otherwise, and other components may in fact be included.

Furthermore, when a certain part “includes” a certain component, other components are not excluded unless explicitly described otherwise, and other components may in fact be included.

In the entire specification of the present disclosure, when any member is located “on” another member, this includes a case in which still another member is present between both members as well as a case in which one member is in contact with another member.

The terms “first,” “second,” and the like are just to distinguish a component from any other component, and components are not limited by the terms.

The singular form of the components may be understood into the plural form unless otherwise specifically stated in the context.

Identification codes in each operation are used not for describing the order of the operations but for convenience of description, and the operations may be implemented differently from the order described unless there is a specific order explicitly described in the context.

Hereinafter, operation principles and embodiments of the present disclosure will be described with reference to the accompanying drawings.

In description of the present disclosure, a ‘call monitoring apparatus’ includes all of various apparatuses capable of executing operational management and providing the operational management results to a user. For instance, the apparatus according to the present disclosure may include all of a computer, a server device, and a portable terminal, or may be configured to have any form of the computer, the server device, and the portable terminal.

Here, the computer may include, for example, a notebook computer equipped with a web browser, a desktop, a laptop, a tablet PC, a slate PC, and the like.

The server device is a server to process information by performing communication with an external device, and may include an application server, a computing server, a database server, a file server, a game server, a mail server, a proxy server, a web server, and the like.

The portable terminal is a wireless communication device providing portability and mobility, and includes all kinds of handheld-based wireless communication devices, such as a Personal Communication System (PCS), a Global System for Mobile communications (GSM), a Personal Digital Cellular (PDC), a Personal Handy-phone System (PHS), a Personal Digital Assistant (PDA), an International Mobile Telecommunication (IMT)-2000, a Code Division Multiple Access (CDMA)-2000, a W-Code Division Multiple Access (W-CDMA), a Wireless Broadband Internet (WiBro), a smartphone, and the like, and a wearable device, such as a watch, a ring, a bracelet, an ankle bracelet, a necklace, glasses, contact lenses, or a Head-Mounted Device (HMD).

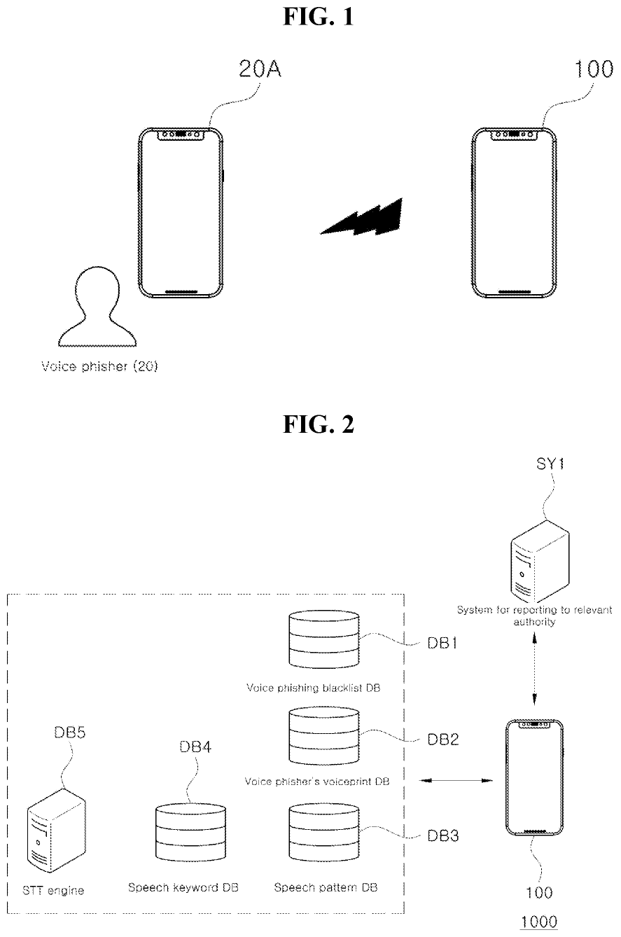

FIG. 1 is a view illustrating a situation that a natural language processing (NLP) based fraudulent call monitoring apparatus for preventing voice phishing according to the present disclosure is applied.

A voice phisher 20 is a person attempting to defraud properties of other people using various methods and can make a call to a call monitoring device 100 through a terminal 20A.

The call monitoring device 100 can verify the caller's phone number, and can recognize the caller's voiceprint, determine whether the recognized voice print is a voiceprint stored in a voice phisher database DB, and analyzes speech keywords and speech patterns based on the natural language processing (NLP) to determine whether the caller is a voice phisher.

Here, the natural language processing (NLP) may be performed through natural language analysis, and the natural language analysis may include morphological analysis, syntactic analysis, semantic analysis, and pragmatic analysis, and may be implemented using artificial intelligence.

The call monitoring device 100 can be included in a system designed to prevent voice phishing.

FIG. 2 is a view illustrating a system for preventing voice phishing according to the present disclosure.

A system 1000 for preventing voice phishing may include the call monitoring device 100, a voice phishing blacklist database DB1, a voice phisher voice database DB2, a speech pattern database DB3, a speech keyword database DB4, a speech to text (STT) engine DB5, and a reporting system SY1 for relevant organizations. According to embodiments, system 1000 for preventing voice phishing may include more database systems, operating systems, and programs.

The voice phishing blacklist database DB1 may be a database for determining whether voice phishing is or is not occurring based on contact information, and the voice phisher voice database DB2 may be a database in which the voiceprints of voice phishers are stored. Moreover, the speech pattern database DB3 may be a database in which voice phishing speech patterns are stored and may also be implemented to output whether the input speech pattern is a voice phishing speech pattern. The speech keyword database DB4 may store voice phishing speech keywords, and the speech to text (STT) engine DB5 may be a system having a program converting speech into text (STT). The databases DB1 to DB4 can be updated in real time depending on the occurrence of voice phishing.

Moreover, the call monitoring device 100 can automatically transmit information about the occurrence or suspicion of voice phishing to relevant institutions (e.g., police agencies, financial institutions) when voice phishing is occurring or is suspected.

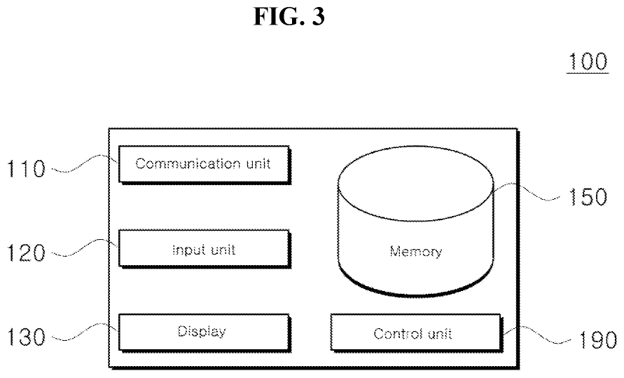

FIG. 3 is a block diagram illustrating a natural language processing (NLP) based fraudulent call monitoring apparatus for preventing voice phishing according to the present disclosure.

The call monitoring device 100 may include a communication unit 110, an input unit 120, a display 130, a memory 150, and a control unit 190. The components illustrated in FIG. 3 are not essential for implementing the call monitoring device 100 according to the present disclosure, and the call monitoring device 100 described in this specification can have more or fewer components than those enumerated above.

Among the above-mentioned components, the communication unit 110 may include one or more components that enable communication with external devices, for example, the communication unit 110 may include at least one of a broadcast reception module, a wired communication module, a wireless communication module, a short-range communication module, and a location information module.

The input unit 120 is for inputting video information (or signals), audio information (or signals), data, or information input by a user, and may include at least one camera, at least one microphone, and at least one user input unit. Voice or image data collected by the input unit 120 can be analyzed and processed via a user control command.

Here, the user input unit is for receiving information from the user. When information is input through the user input unit, the control unit 190 can control the operation of the device corresponding to the input information. Such a user input unit may include physical hardware keys (e.g., buttons located on at least one of the front, back, or side of the device, dome switches, jog wheels, jog switches, etc.) and software-based touch keys. For example, the touch keys may be virtual keys, soft keys, or visual keys displayed on a touchscreen display through software processing or touch keys arranged outside the touchscreen. Meanwhile, the virtual or visual keys may be displayed in various forms on the touchscreen, and can consist of graphics, text, icons, videos, or a combination thereof.

The display 130 displays (outputs) information processed in this apparatus. For example, the display 140 can display execution screen information of the application run on the server, or user interface (UI) information or graphic user interface (GUI) information based on such execution screen information.

The memory 150 can store data supporting various functions of this apparatus and programs for the operation of the control unit 190, can store input/output data (for example, music files, still images, videos, etc.), and can store a plurality of application programs (called, application program or application), data for the operation of this apparatus, and commands. At least some of these applications can be downloaded from an external server via wireless communication.

The memory 150 may include a storage medium having at least one among a flash memory type memory, a hard disk type memory, a solid state disk type (SSD), a silicon disk drive type (SDD), a multimedia card micro type memory, a card type memory (e.g., an SD memory or an XD memory), a random access memory (RAM), static random access memory (SRAM), read-only memory (ROM), an electrically erasable programmable read-only memory (EEPROM), a programmable read-only memory (PROM), a magnetic memory, a magnetic disk, and an optical disk. Furthermore, the memory may also be a database that is separated from this apparatus but is connected to this apparatus wired or wirelessly.

The memory 150 can store one or more models trained using a machine learning algorithm.

The control unit 190 can be implemented as a memory storing algorithms or programs that reproduce the algorithms for controlling the operations of the components within this apparatus, and at least one processor (not illustrated) that performs the above-mentioned operations using the data stored in the memory. In this case, the memory and the processor can each be implemented as separate chips, or can be implemented as a single chip.

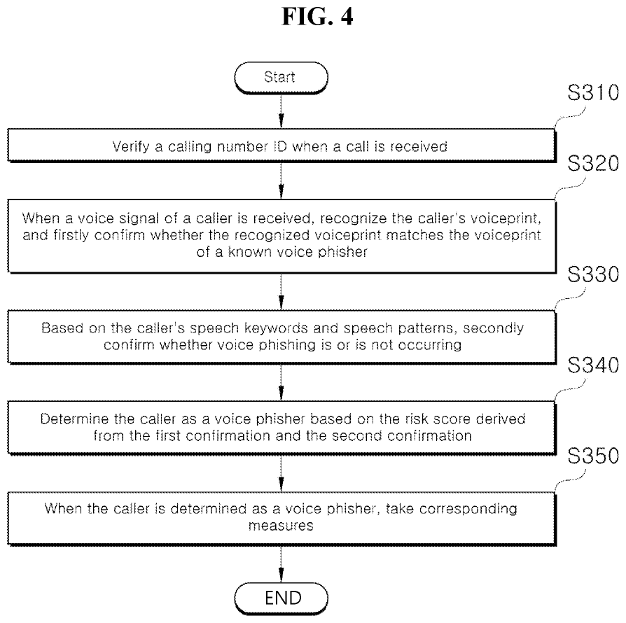

Furthermore, the control unit 190 can control through combination of one or more of the components described above to implement the various embodiments according to the present disclosure as illustrated in FIGS. 4 to 7 on the server.

At least one component can be added or deleted in response to the performance of the components illustrated in FIG. 3. Additionally, it will be readily understood by those having ordinary skill in the art that the relative positions of the components can be changed in accordance with the performance or structure of the system.

Meanwhile, each of the components illustrated in FIG. 3 refers to software and/or hardware components such as field programmable gate array (FPGA) and an application specific integrated circuit (ASIC), which is a custom semiconductor.

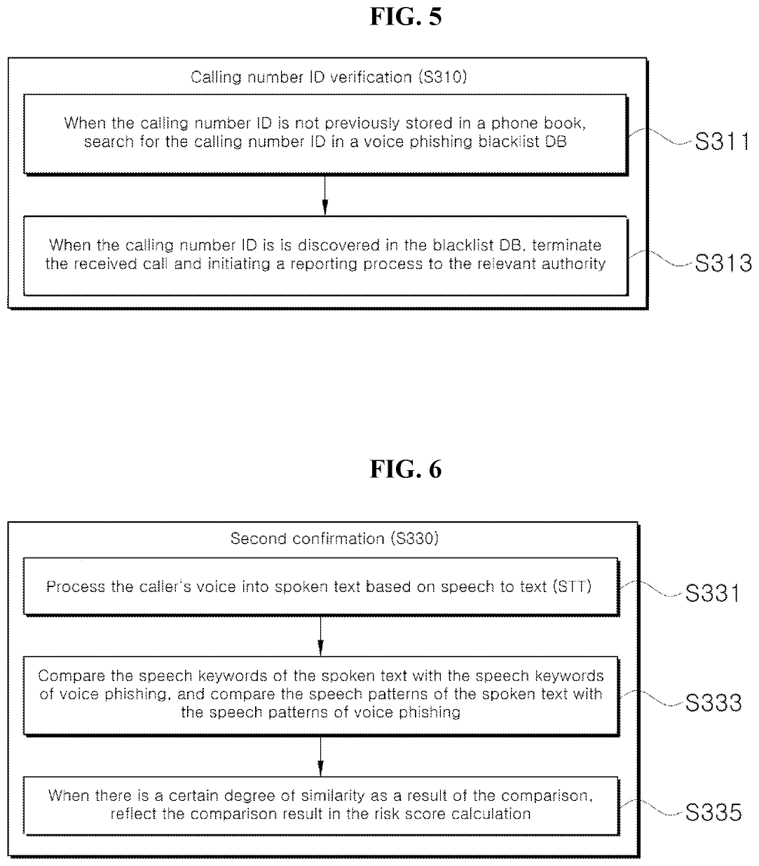

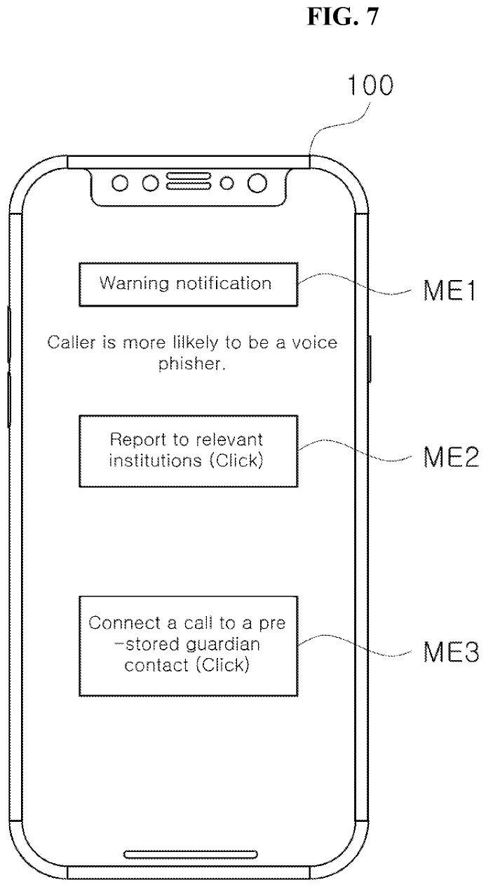

FIG. 4 is a sequence chart illustrating a natural language processing (NLP) based fraudulent call monitoring method for preventing voice phishing according to the present disclosure, FIG. 5 is a sequence chart depicting a calling number ID verification method for preventing voice phishing according to the present disclosure, FIG. 6 is a sequence chart depicting a method of analyzing speech patterns and speech keywords for preventing voice phishing according to the present disclosure, and FIG. 7 is a view depicting a user interface of the NLP based fraudulent call monitoring apparatus for preventing voice phishing according to the present disclosure. If necessary, FIGS. 5 to 7 are referred while FIG. 4 is described.

The control unit 190 can verify a calling number ID which receiving a call (S310).

Referring to FIG. 5, when the calling number ID is not previously stored in a phone book, the control unit 190 can search for the calling number ID in the voice phishing blacklist database DB (S311).

Here, the phone book can be a contact list stored in the memory 150 of the call monitoring device 100. The voice phishing blacklist DB can be an external database or a database stored in the memory 150.

When the calling number ID is discovered in the blacklist DB, the control unit 190 can terminate the received call and proceed with a report process to the relevant agency (S313).

In an optional embodiment, the control unit 190 can output a warning notification to the display 130 without terminating the received call, and execute a recording trigger command.

Moreover, the control unit 190 can report the calling number ID to various relevant agencies, such as police departments, various reporting centers, etc.

when the call location of the calling number ID is international and not domestic, the control unit 190 can recognize it as a dangerous situation even if the calling number ID is not discovered in the voice phishing blacklist DB.

The control unit 190 can calculate a risk score to determine voice phishing, and when the call location of the calling number ID is not domestic but international, even if the calling number ID is searched from the voice phishing blacklist DB, a weighted value can be applied and reflected in calculation of the risk score.

Additionally, the control unit 190 can trigger a call recording command, record the call, and transmit the recorded call to the relevant agency or store it in the memory 150.

In FIG. 4, after operation S310, when receiving the voice signal of the caller, the control unit 190 can recognize the voiceprint of the caller, and firstly confirm whether the recognized voiceprint is that of a voice phisher (S320).

The control unit 190 can search the recognized voiceprint of the caller in the voice phisher voiceprint DB. Here, the voice phisher voiceprint DB can be provided on an external server, but is not limited thereto.

When the voiceprint is searched, the control unit 190 can reflect the searched result in the risk score calculation, and when the call recording is not in progress, the control unit 190 can trigger a call recording command.

In a case in which the caller claims to have kidnapped a recipient's family member or acquaintance and provides the kidnapped person's voice for verification, the control unit 190 can compare the voiceprint of the provided voice with the previously stored voiceprint of the family member or acquaintance.

When the comparison result shows a predetermined (or preset) similarity, the control unit 190 can reflect the comparison result in the risk score calculation. For instance, when there is no difference between the two voiceprints (i.e., they are identical), the control unit 190 can determine it as an actual kidnapping and report to the relevant authorities. When there's a significant difference between the two voiceprints, the control unit 190 can reflect it to the calculation of the voice phishing risk score.

In FIG. 4, after the S320 operation, the control unit 190 can secondly confirm whether voice phishing is or is not occurring based on the caller's speech keywords and speech patterns (S330).

Referring to FIG. 6, the control unit 190 can process the caller's voice into speech text using speech to text (STT). For this, the control unit 190 can utilize an external STT engine, but is not limited thereto.

The control unit 190 can compare the speech keywords of the speech text with the voice phishing speech keywords, and compare the speech patterns of the speech text with the voice phishing speech patterns.

The control unit 190 can compare the voice phishing keyword database with the collected caller's speech keywords, and reflect the comparison results to the calculation of the voice phishing risk score based on the frequency of keywords, and usage of risky keywords, and so on.

The control unit 190 can compare the voice phishing speech pattern database with the collected caller's speech patterns, and when there is a predetermined (or preset) similarity based on whether pitch, speed, and face are constant due to script reading, whether specific dialects (e.g., dialects of ethnic Koreans in China) are used, and the distance between voice phishing related keywords, the control unit 190 can reflect it in the risk score calculation. To detect specific dialects, the control unit 190 may use a separately trained model.

In a case in which the risk score exceeds a certain level through the verification and the first confirmation, even if the comparison result using speech patterns and speech keywords is lower than a predetermined (or preset) level, it may be reflected in the risk score calculation.

In other words, even if it is determined that it is dangerous because the calling number ID and/or the caller's voiceprint exceed the predetermined level and the comparison result using speech patterns and speech keywords is lower than the predetermined (or preset) level due to the use of new methods, the control unit 190 can reflect apply weighted values and reflect it in the risk score calculation. Therefore, the present disclosure can actively prepare for new/variant voice phishing methods.

In FIG. 4, after the S330 operation, the control unit 190 can determine the caller as a voice phisher based on the risk score through the first confirmation and the second confirmation (S340).

In an embodiment, when determining the caller as a voice phisher, the control unit 190 can utilize a pre-trained model at the time of the risk score calculation. The model can be trained by assigning weighted values to at least one of a case in which the calling number ID is not stored in the phone book, a case in which a call is received from an international source, a case in which the caller's voice has a certain (or pre-set) similarity with a preregistered voice phisher's voice, a case in which the caller's speech keywords have a certain (or pre-set) similarity with frequently used keywords by voice phishers, and a case in which the caller's speech pattern has a certain (or pre-set) similarity with the speech pattern of a voice phisher.

The relevant learning model can calculate a risk score or stochastically determine whether voice phishing is or is not occurring based on the calculated risk score. For instance, the model may output that the caller has an 85% or higher probability of being a voice phisher.

The control unit 190, after operation S340, can take corresponding actions when the caller is determined to be a voice phisher (S350).

Referring to FIG. 7, the control unit 190 can provide a warning notification ME1 when there is a high probability that the caller is a voice phisher, and can activate a button ME2 to report to the relevant authorities.

In addition, the control unit 190 can provide a menu ME3 to connect a call to a preregistered guardian contact, and when a user clicks, can initiate the call connection through the communication unit 110. In an optional embodiment, the control unit 190 can automatically connect the call to the guardian's contact.

Furthermore, the control unit 190 can automatically send and report the guardian at least one among contact information (for instance, phone number) of a connected call maker (voice phisher), information on call time (calling date), call details obtained through speech to text recognition during taking over the phone, and a summary of the call details in the form of an SNS message (for example, KakaoTalk™) or a text message (SMS or MMS).

On the other hand, the disclosed embodiments may be implemented in the form of a recording medium storing instructions executable by a computer. Instructions may be stored in the form of program code and, when executed by a processor, may generate a program module to perform operation of the disclosed embodiments. The recording medium may be embodied as a computer-readable recording medium.

The computer readable recording medium includes all kinds of recording media in which instructions that can be decrypted by a computer are stored. For example, there may be a read-only memory (ROM), a random access memory (RAM), a magnetic tape, a magnetic disk, a flash memory, an optical data storage device, and the like.

The above description is only exemplary, and it will be understood by those skilled in the art that the disclosure may be embodied in other concrete forms without changing the technological scope and essential features. Therefore, the above-described embodiments should be considered only as examples in all aspects and not for purposes of limitation.

The natural language processing (NLP) based fraudulent call monitoring method for preventing voice phishing, and an apparatus and a program therefor according to the present disclosure can quickly detect a voice phisher through analysis of the caller's voiceprint, speech patterns, and speech keywords, thereby preventing voice phishing damages in advance.

The advantages of the present disclosure are not limited to the above-mentioned advantages, and other advantages, which are not specifically mentioned herein, will be clearly understood by those skilled in the art from the following description.

1. A natural language processing (NLP) based call monitoring method for preventing voice phishing, comprising the operations of:
verifying a calling number ID when a call is received;
when a voice signal of a caller is received, recognizing the caller's voiceprint, and firstly confirming whether the recognized voiceprint matches the voiceprint of a known voice phisher;
based on the caller's speech keywords and speech patterns, secondly confirming whether voice phishing is or is not occurring;
determining the caller as a voice phisher based on the risk score derived from the first confirmation and the second confirmation; and
when the caller is determined as a voice phisher, taking corresponding measures.

2. The call monitoring method according to claim 1, wherein the operation of verifying the calling number ID comprises the operations of:
when the calling number ID is not previously stored in a phone book, searching for the calling number ID in a voice phishing blacklist database (DB); and
when the calling number ID is is discovered in the blacklist DB, terminating the received call and initiating a reporting process to the relevant authority.

3. The call monitoring method according to claim 2, wherein the operation of verifying the calling number ID comprises the operations of:
when the call location of the calling number ID is not domestic but international, even if the calling number ID is not discovered in the voice phishing blacklist DB, reflecting the calling number ID in the risk score calculation; and
triggering a call record command.

4. The call monitoring method according to claim 3, wherein the firstly confirming operation comprises the operations of:
searching for the recognized voiceprint of the caller in a voice phisher voiceprint DB;
when the voiceprint of the caller is recognized, reflecting the voiceprint in the risk score calculation; and
triggering a call record command.

5. The call monitoring method according to claim 4, wherein the firstly confirming operation comprises the operations of:
when the caller claims to have kidnapped a recipient's family member or acquaintance and provides the kidnapped person's voice for verification, comparing the voiceprint of the provided voice with the previously stored voiceprint of the family member or acquaintance; and
when the comparison result shows a predetermined similarity, reflecting the comparison result in the risk score calculation.

6. The call monitoring method according to claim 5, wherein the secondly confirming operation comprises the operations of:
processing the caller's voice into spoken text based on speech to text (STT);
comparing the speech keywords of the spoken text with the speech keywords of voice phishing, and comparing the speech patterns of the spoken text with the speech patterns of voice phishing; and
when there is a certain degree of similarity as a result of the comparison, reflecting the comparison result in the risk score calculation.

7. The call monitoring method according to claim 6, wherein the secondly confirming operation comprises the operations of:
when the risk score, as a result of the verification and the first confirmation, exceeds a predetermined level, even if the comparison result using speech patterns and speech keywords is lower than a predetermined level, reflecting the result in the risk score calculation.

8. The call monitoring method according to claim 7, wherein the operation of determining the caller as a voice phisher comprises the operations of:
utilizing a pre-trained model at the time of the risk score calculation,
wherein the model is trained by assigning weighted values to at least one of a case in which the calling number ID is not stored in the phone book, a case in which a call is received from an international source, a case in which the caller's voice has a certain similarity with a preregistered voice phisher's voice, a case in which the caller's speech keywords have a certain (or pre-set) similarity with frequently used keywords by voice phishers, and a case in which the caller's speech pattern has a certain similarity with the speech pattern of a voice phisher.

9. A non-transitory computer readable recording medium storing software that, when executed by an apparatus, causes a hardware processor of the apparatus to execute the call monitoring method of claim 1.

10. A natural language processing (NLP) based call monitoring apparatus, comprising:
a communication unit; and
a control unit which verifies a calling number ID when a call is received, recognizes the caller's voiceprint when a voice signal of a caller is received, firstly confirms whether the recognized voiceprint matches the voiceprint of a known voice phisher, and based on the caller's speech keywords and speech patterns, secondly confirms whether voice phishing is or is not occurring,
wherein the control unit determines the caller as a voice phisher based on the risk score derived from the first confirmation and the second confirmation, and when the caller is determined as a voice phisher, takes corresponding measures.
